(19) United States
(12) Patent Application Publication
(10) Pub. No.: US 2009/0148953 A1
(43) Pub. Date: Jun. 11, 2009

(54) DETERMINING METHOD OF INK FOR INK-JET RECORDING OR RECORDED MATTER, INK FOR INK-JET RECORDING AND INK SET FOR INK-JET RECORDING

(75) Inventor: Hitomi Sadohara, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/332,148

(22) Filed: Dec. 10, 2008

(30) Foreign Application Priority Data
Dec. 10, 2007 (JP) 2007318940

(51) Int. Cl. G01N 31/22; C09D 11/02

(52) U.S. Cl. 436/163; 106/31.92; 106/31.6

(57) ABSTRACT

A determining method is provided which can more easily determine whether an ink contains an amphoteric metal oxide or whether a recorded matter is recorded with an ink containing an amphoteric metal oxide. The determining method includes applying an acidic aqueous solution or an alkaline aqueous solution to an ink for ink-jet recording or a recorded portion of a recorded matter recorded with an ink for ink-jet recording, and observing pH change.

### CROSS REFERENCE TO RELATED APPLICATION

The present invention claims a priority from Japanese Patent Application No. 2007-318940, which was filed on Dec. 10, 2007, the disclosure of which is herein incorporated by reference in its entirety.

### BACKGROUND

1. Field of the Invention

The present invention relates to a determining method which may easily determine whether an ink for ink-jet recording (hereinafter, “ink for ink-jet recording” is sometimes referred to as “ink”) comprises an amphoteric metal oxide, or whether a recorded matter is recorded with an ink comprising an amphoteric metal oxide, and to such an ink, a producing method of such an ink, and to an ink set, to which this determining method is applied.

2. Description of the Related Art

Recently, due to rapid improvements in the performance of color printing machines and copying machines, it is becoming more and more difficult to at a glance distinguish an original from a copy thereof. These machines are being used to forge printed matter, such as certificates and the like.

On the other hand, methods have been proposed for determining the authenticity of a printed matter. Such methods include determining authenticity by using a magnetic ink in the printing, and putting the resultant printed matter through a magnetic ink reading apparatus, determining authenticity by using an ink which includes a special dye that absorbs visible light and emits fluorescent light, and measuring the intensity of the fluorescent light of the printed matter with an optical reading apparatus, and the like.

Furthermore, in a printer for ink-jet recording, because a variety of inks are used according to the ink ejection system, type of recording material and the like, in some printers if an ink is used which is not adapted to that particular printer's specifications, solidification or deposition can occur in the ink-jet nozzles, whereby printing cannot be carried out normally. To allow determination of whether an ink is adapted to a particular printer, a method has been proposed which assembles a nonvolatile memory in an ink cartridge for storing the type and remaining amount of ink.

In the above-described determination of the authenticity of a printed matter, an expensive reading apparatus is required. Furthermore, to ensure that inks adapted to a particular printer are used, in the method which assembles a nonvolatile memory in the ink cartridge, an exclusive ink cartridge has to be used. Moreover, the authenticity of the ink itself which is filled in the ink cartridge cannot be verified.

### SUMMARY

In contrast, it is an object to provide a method which may more easily determine whether an ink comprises an amphoteric metal oxide and whether an amphoteric metal oxide is comprised in an ink used for recording a recorded matter, so that a determination as to whether an ink is adapted to a certain printer for ink-jet recording and as to the authenticity of a recorded matter may be easily carried out.

The present inventor discovered that if an ink comprising an amphoteric metal oxide is used for the ink to be determined, by applying an acidic aqueous solution or an alkaline aqueous solution to an arbitrary ink which is the determination target or a recorded matter which used the arbitrary ink, the ink to be determined or the recorded matter recorded with the ink to be determined may be very easily determined by observation of pH change. This is because, although in the ink to be determined the acidic aqueous solution or alkaline aqueous solution is neutralized due to the effects of the amphoteric metal oxide, in an ink which does not comprise an amphoteric metal oxide, such neutralization does not occur.

An aspect of the present invention provides a determining method for determining whether an ink comprises an amphoteric metal oxide or whether a recorded matter was recorded with an ink comprising an amphoteric metal oxide, wherein the determining method comprises applying an acidic aqueous solution or an alkaline aqueous solution to an ink or a recorded portion of a recorded matter recorded with the ink, and observing pH change.

Another aspect of present invention provides a producing method for producing an ink, where the ink is applied to a determining method for determining whether an ink comprises an amphoteric metal oxide or whether a recorded matter was recorded with an ink comprising an amphoteric metal oxide, the determining method comprises applying an acidic aqueous solution or an alkaline aqueous solution to an ink or a recorded portion of a recorded matter recorded with the ink, and observing pH change, wherein the amphoteric metal oxide is comprised in the ink in a dispersed state.

Still another aspect of the present invention provides an ink for piezo type ink-jet recording which is applied a determining method for determining whether an ink comprises an amphoteric metal oxide or whether a recorded matter was recorded with an ink comprising an amphoteric metal oxide, the determining method comprising applying an acidic aqueous solution or an alkaline aqueous solution to an ink or a recorded portion of a recorded matter recorded with the ink, and observing pH change, wherein the amphoteric metal oxide is comprised in a dispersed state.

In addition, a furthermore aspect of the present invention provides an ink set for ink-jet recording which is applied to a determining method for determining whether an ink comprises an amphoteric metal oxide or whether a recorded matter was recorded with an ink comprising an amphoteric metal oxide, the determining method comprising applying an acidic aqueous solution or an alkaline aqueous solution to an ink or a recorded portion of a recorded matter recorded with the ink, and observing pH change, wherein the ink set comprises a plurality of different color inks, and at least one of the color inks comprises the amphoteric metal oxide.

### DETAILED DESCRIPTION OF THE PREFERRED EMBODIMENTS

The present invention will now be described in more detail.

The determining method utilizes an amphoteric metal oxide which exhibits a neutralizing effect, and preferably a buffering effect, against an acidic aqueous solution or an alkaline aqueous solution. When an acidic aqueous solution or an alkaline aqueous solution is applied to a determination target arbitrary ink or a determination target recorded matter obtained from the arbitrary ink, and the pH at that time is observed, if a neutralizing effect or buffering effect is confirmed, the determination target ink or recorded matter is determined as being an ink which comprises an amphoteric metal oxide or a recorded matter recorded with an ink comprising an amphoteric metal oxide. If a neutralizing effect or buffering effect is not confirmed, the determination target ink or the determination target recorded matter is determined as being an ink which does not comprise an amphoteric metal oxide or a recorded matter recorded with an ink which does not comprise an amphoteric metal oxide. As a result, when an ink which comprises an amphoteric metal oxide is used as the ink to be determined, the ease with which determination may be made is improved.

By using an ink which comprises an amphoteric metal oxide for the ink which is adapted to a specific model of a printer for ink-jet recording, whether the ink comprising an amphoteric metal oxide was used in an ink remaining in the head, ink cartridge or the like of an arbitrary printer, or was used in an arbitrary recorded matter recorded with ink, may be very easily determined by observation of pH change. The maintenance efficiency of a printer for ink-jet recording may be improved.

Furthermore, by producing a printed matter such as a certificate or the like with an ink comprising an amphoteric metal oxide, it may be easily determined whether that printed matter was produced with an ink comprising an amphoteric metal oxide.

Examples of the amphoteric metal oxide include, without any limitations, zinc oxide, aluminum oxide, tin oxide, lead oxide and the like. Furthermore, the amphoteric metal oxide is in the form of fine particles which are dispersible in ink. More specifically, it is preferred that the fine particles have an average particle diameter of about 200 nm or less. As a result, the surface area thereof is increased, and the neutralizing capacity against the acidic aqueous solution or the alkaline aqueous solution may be increased. Furthermore, the nozzles of the ink-jet recording head may be prevented from clogging. In addition, the coloring may be prevented from being affected by a decrease in the transparency of a recorded image. Specific examples of the amphoteric metal oxide include, without any limitations, for zinc oxide, DENASYS® Y-UMN (manufactured by Nagase Colors & Chemicals Co., Ltd.), zinc oxide nanoparticles ZnO-310 (manufactured by Sumitomo Osaka Cement Co., Ltd.), Maxlight® ZS-032 (manufactured by Showa Denko K.K.) and the like, for aluminum oxide, NANOBYK-3600 (manufactured by BYK Chemie Japan) and the like, and for tin oxide, ESP (manufactured by Yamanaka & Co., Ltd.), AS11T (manufactured by Unitika Ltd.), AS20I (manufactured by Unitika Ltd.) and the like.

When applying the determining method to distinguish an ink adapted to a specific model of printer or an ink used in the production of a specific certificate and the like from some other ink, an amphoteric metal oxide is comprised in the ink to be determined. In such case, the amount of the amphoteric metal oxide, with respect to the total amount of ink, is in the range of from about 0.1 wt % to about 10 wt %, in the range of from about 0.5 wt % to about 10 wt %, and in the range of from about 0.5 wt % to about 5 wt %. If the amount of the amphoteric metal oxide is less than about 0.1 wt %, even if an acidic aqueous solution or an alkaline aqueous solution is applied to the ink to be determined or a recorded matter recorded with the ink to be determined, the acidic aqueous solution or the alkaline aqueous solution is not sufficiently neutralized by the amphoteric metal oxide in the ink or the recorded matter, or the buffering effects may not be sufficiently expressed, which makes it more difficult to distinguish the ink to be determined from other inks. On the other hand, if the amount of the amphoteric metal oxide is more than about 10 wt %, clogging tends to occur in the nozzle portions of the ink-jet recording head, which is not preferable.

Furthermore, the pH of the ink comprising the amphoteric metal oxide is adjusted to a pH at which the amphoteric metal oxide has an acid neutralizing capacity or alkaline neutralizing capacity, and to a pH at which a buffering effect of the amphoteric metal oxide may be maintained.

In cases where there are a plurality of kinds of ink which need to be determined by the method according to the model of printer, the kind of printed matter and the like, a plurality of inks having differing amounts of amphoteric metal oxide in the ink may be used.

Examples of applying the acidic aqueous solution or the alkaline aqueous solution to the ink include, without any limitations: (1) collecting an arbitrary ink remaining in the ink cartridge, ink tank, ink-jet head interior or the like, and dropping the acidic aqueous solution or the alkaline aqueous solution therein; (2) dropping an arbitrary ink remaining in the ink cartridge, ink tank, ink-jet head interior or the like in the acidic aqueous solution or the alkaline aqueous solution; and the like. Furthermore, examples of applying the acidic aqueous solution or the alkaline aqueous solution to the recorded portion of a recorded matter obtained from the ink include, without any limitations: (a) dropping the acidic aqueous solution or the alkaline aqueous solution in an arbitrary recorded portion; (b) dipping the recorded portion in an arbitrary acidic aqueous solution or an arbitrary alkaline aqueous solution; (c) impressing a stamp which comprises the acidic aqueous solution or the alkaline aqueous solution onto an arbitrary recorded portion; and the like.

The acidic aqueous solution may be used in cases where the pH of an arbitrary ink or recorded portion which is the determination target is weakly acidic to alkaline. As a result, when the acidic aqueous solution is applied to the ink or the recorded portion to be determined, the pH is more easily maintained close to neutral due to the buffering effect of the amphoteric metal oxide, whereby the ink or the recorded portion to be determined may be determined. Similarly, the alkaline aqueous solution may be used in cases where the pH of an arbitrary ink or the recorded portion which is the determination target is weakly alkaline to acidic. As a result, when the alkaline aqueous solution is applied to the ink or the recorded portion to be determined, the pH is more easily maintained close to neutral due to the buffering effect of the amphoteric metal oxide, whereby the ink or the recorded portion to be determined may be determined. Furthermore, in an ink which does not comprise an amphoteric metal oxide, because no neutralizing effect is expressed against either an acidic aqueous solution or an alkaline aqueous solution, by applying both an acidic aqueous solution and an alkaline aqueous solution and observing the trend of pH change, it may be determined whether the ink is the ink to be determined or not.

The pH of the acidic aqueous solution is a pH of about 1.5 to about 4.0, a pH of about 1.5 to about 3.5, and a pH of about 1.8 to about 3.5, depending on the concentration of the amphoteric metal oxide comprised in the ink to be determined. If the pH of the acidic aqueous solution is less than about 1.5, even if the acidic aqueous solution is applied to the ink to be determined comprising an amphoteric metal oxide, or a recorded portion obtained from such ink, the acidic aqueous solution cannot be sufficiently neutralized with the amphoteric metal oxide. As a result, the expression of a buffering effect in the amphoteric metal oxide also becomes difficult, which makes it more difficult to observe the difference between the pH of the acidic aqueous solution before applying to the ink or the recorded portion obtained therefrom and the pH of the acidic aqueous solution after application. To overcome this problem, while the ink for applying the acidic aqueous solution may be concentrated by drying, or the amount of amphoteric metal oxide contributing to the neutralization of the acidic aqueous solution may be increased by carrying out duplicate printing, such techniques are not preferred as they make the process more complex. Furthermore, if the pH of the acidic aqueous solution is more than about 4.0, because the pH is too close to neutral, in such a case it becomes more difficult to observe the difference between the pH of the acidic aqueous solution before applying to the ink or the recorded portion obtained therefrom and the pH of the acidic aqueous solution after application.

Similarly also for the alkaline aqueous solution, from the standpoint of making it easier to observe the difference between the pH before applying to the ink or the recorded portion obtained therefrom and the pH after application, the solution is not made strongly alkaline. The alkaline aqueous solution has a pH of about 8.5 to about 12.0, a pH of about 9.0 to about 11.5, and a pH of about 9.0 to about 11.0.

Examples of the acidic aqueous solution include, without any limitations, aqueous solutions of acrylic acid, adipic acid, acetoacetic acid, benzoic acid, isocitric acid, isobutyric acid, ethylenediamine tetraacetic acid, formic acid, citric acid, glyoxylic acid, succinic acid, acetic acid, salicylic acid, oxalic acid, tartaric acid, stearic acid, terephthalic acid, trifluoroacetic acid, lactic acid, pyruvic acid, phthalic acid, fumaric acid, propionic acid, gallic acid (3,4,5-trihydroxybenzoic acid), maleic acid, malonic acid, monofluoroacetic acid, malic acid and the like.

Examples of the alkaline aqueous solution include, without any limitations, aqueous solutions of ammonia, methylamine, ethylamine, dimethylamine, diethylamine, trimethylamine, triethylamine, triethanolamine, N,N-diisopropylethylamine, piperidine, piperazine, morpholine, pyridine, tetramethylethylenediamine and the like.

Examples of the method for observing the change in pH before and after the application of the acidic aqueous solution or the alkaline aqueous solution to the ink or the recorded portion obtained from the ink include, without any limitations, a method in which a pH indicator along with the acidic aqueous solution or the alkaline aqueous solution is applied to the ink or the recorded portion obtained from the ink, a method in which a pH test paper or a pH meter is used in the ink or on the recorded portion obtained therefrom, and the like.

The pH indicator is capable of determining the pH of the acidic aqueous solution or the alkaline aqueous solution of about 5.5 to about 8 in a state which is neutralized or buffered by the amphoteric metal oxide.

Examples of the pH indicator include, without any limitations, bromocresol green, methyl red, litmus, methyl purple, bromocresol purple, chlorophenol red, bromothymol red, p-nitrophenol, phenol red, universal indicator, cresol red, thymol blue, phenolphthalein and the like. In the case of using a pH indicator, during application to the ink or the recorded portion obtained therefrom, a mixed solution in which the acidic aqueous solution or the alkaline aqueous solution and the pH indicator have been mixed in advance may be applied (dropping, dipping, impression).

Basically, compositions of the ink to be determined and compositions of an arbitrary ink as a determination target are not limited, and these inks may be composed as a colored ink or a colorless ink, provided that the ink to be determined comprise amphoteric metal oxide as an essential component. If the ink which is to be determined is a colored ink, pigment inks do not usually require an amphoteric metal oxide to be added as an ultraviolet ray absorber. Thus, from the standpoint of improving determination accuracy, it is preferred to have a pigment ink which uses a pigment as the coloring agent. Furthermore, from the standpoint of improving determination accuracy, it is also preferred to have an ink which is used in a printer for piezo type ink-jet recording, which does not require the amphoteric metal oxide to be added as thermally-conductive fine particles.

Ink sets capable of recording full color images are formed from a yellow ink, a magenta ink, and a cyan ink, or a black ink to which these inks have been added. As an ink set for determination, the set may be formed with inks all of which comprise an amphoteric metal oxide, or with inks in which at least one of the color inks comprises an amphoteric metal oxide. It is preferred to form the set with a black ink comprising an amphoteric metal oxide, so that the effects on the colors as a result of comprising an amphoteric metal oxide may be suppressed as much as possible.

When using a pigment as the ink to be determined or as a coloring agent of an ink which forms an ink set along with the ink to be determined, examples of the black pigments include, without any limitations, MA8 and MA100 (manufactured by Mitsubishi Chemical Corporation), and carbon blacks such as Carbon Black FW 200 (manufactured by Degussa) and the like. Furthermore, self-dispersible pigments which may be dispersed or dissolved in water without the use of a dispersant may also be used. Self-dispersible pigments may be obtained by subjecting the surface thereof to surface treating so that at least one kind of a hydrophilic group or salt thereof, such as a carbonyl group, a carboxyl group, a hydroxyl group, or a sulfone group, is bonded to the pigment surface. Examples of such self-dispersible pigments may include, without any limitations, self-dispersible pigments etc. which have been surface-treated by a method described in Japanese Patent Application Laid-Open No. H8-3498 and Japanese Translation of PCT International Application No. 2000-513396. Examples of self-dispersible pigments which may also be used include, without any limitations, CAB-O-JET® 200 and 300 (manufactured by Cabot Corporation), Bonjet® CW1 (manufactured by Orient Chemical Industries, Ltd.) and the like. Examples of yellow pigments include, without any limitations, C.I. Pigment Yellows 3, 13, 74, 83, 154 and the like. Examples of magenta pigments include, without any limitations, C.I. Pigment Reds 5, 48, 112, 122, 177, 202, 207 and the like. Examples of cyan pigments include, without any limitations, C.I. Pigment Blues 15, 15:3, 15:4, 16, 60 and the like.

Although the amount of the pigment in the ink depends on the desired print density and color, it is in the range of from about 0.1 wt % to about 10 wt %, and in the range of from about 0.3 wt % to about 7 wt %, with respect to the total amount of the ink. If the pigment amount is less than about 0.1 wt %, color development on the recording material tends to be insufficient, which is not preferable, while if the pigment amount is more than about 10 wt %, the nozzles of the ink-jet recording head tend to clog, which is not preferable.

When water soluble dyes are used as coloring agents for the ink, they satisfy the required vividness, water solubility, stability, light fastness, ozone resistance and other required properties. Examples of the dye include, without any limitations, various types of dyes such as direct dyes, acid dyes, basic dyes, reactive dyes and the like. These exemplary dyes are classified according to their structure into azo dyes, metal complex dyes, naphthol dyes, anthraquinone dyes, indigo dyes, carbonium dyes, quinoneimine dyes, xanthene dyes, aniline dyes, quinoline dyes, nitro dyes, nitroso dyes, benzoquinone dyes, naphthoquinone dyes, phthalocyanine dyes, metal phthalocyanine dyes and the like.

Examples of the direct dye include, without any limitations: C.I. Direct Blacks 17, 19, 32, 51, 71, 108, 146, 154, 168 and the like; C.I. Direct Yellows 12, 24, 26, 27, 28, 33, 39, 58, 86, 98, 100, 132, 142 and the like; C.I. Direct Reds 4, 17, 28, 37, 63, 75, 79, 80, 83, 99, 220, 224, 227 and the like; C.I. Direct Violets 47, 48, 51, 90, 94 and the like; C.I. Direct Blues 1, 6, 8, 15, 22, 25, 71, 76, 80, 86, 90, 106, 108, 123, 163, 165, 199, 226 and the like.

Examples of the acidic dye include, without any limitations: C.I. Acid Blacks 2, 7, 24, 26, 31, 52, 63, 112, 118 and the like; C.I. Acid Yellows 3, 11, 17, 19, 23, 25, 29, 38, 42, 49, 59, 61, 71, 72 and the like; C.I. Acid Reds 1, 6, 8, 17, 18, 32, 35, 37, 42, 51, 52, 57, 80, 85, 87, 92, 94, 115, 119, 131, 133, 134, 154, 181, 186, 249, 254, 256, 289, 315, 317, 407 and the like; C.I. Acid Violets 10, 34, 49, 75 and the like; C.I. Acid Blues 9, 22, 29, 40, 59, 62, 93, 102, 104, 113, 117, 120, 167, 175, 183, 229, 234 and the like.

Examples of the basic dye include, without any limitations: C.I. Basic Black 2 and the like; C.I. Basic Yellow 40 and the like; C.I. Basic Reds 1, 2, 9, 12, 13, 14, 37 and the like; C.I. Basic Violets 7, 14, 27 and the like; C.I. Basic Blues 1, 3, 5, 7, 9, 24, 25, 26, 28, 29 and the like.

Examples of the reactive dye include, without any limitations: C.I. Reactive Yellows 2, 3, 13, 15 and the like; C.I. Reactive Reds 4, 23, 24, 31, 56, 180 and the like; and C.I. Reactive Blues 7, 13, 21 and the like.

Although the amount of the water soluble dye in the ink depends on the desired print density and color, it is in the range of from about 0.1 wt % to about 10 wt %, in the range of from about 0.3 wt % to about 10 wt %, and in the range of from about 0.3 wt % to about 7 wt %, with respect to the total amount of the ink. If the amount of the water soluble dye is less than about 0.1 wt %, color development on the recording material tends to be insufficient, which is not preferable, while if the amount of the water soluble dye is more than about 10 wt %, the nozzles of the ink-jet recording head tend to clog, which is not preferable.

The ink comprises water. Deionized water or ion-exchanged water is used. The amount of water depends on the type of the water soluble organic solvent used, the composition of the ink and the desired characteristics of the ink and is determined over a wide range. The amount of water, with respect to the total amount of the ink, is in the range of from about 10 wt % to about 95 wt %, in the range of from about 10 wt % to about 80 wt % and in the range of from about 20 wt % to about 80 wt %. When the amount of water is less than about 10 wt %, the viscosity of the ink increases to cause difficulty in ejecting the ink. When the amount of water is more than about 95 wt %, the coloring agent or an additive is precipitated and/or aggregated due to the evaporation of water, so that nozzles of an ink-jet recording head is more likely to be clogged.

The ink further comprises water soluble organic solvents, such as a humectant and a penetrant, used commonly in ink-jet recording inks.

The humectant is added to the ink to prevent clogging of nozzles of an ink-jet recording head. Examples of the humectant include, without any limitations, water soluble glycols such as glycerin, ethylene glycol, diethylene glycol, triethylene glycol, polyethylene glycol, propylene glycol, dipropylene glycol, tripropylene glycol, polypropylene glycol 1,5-pentanediol, 1,6-hexanediol and the like. The amount of the humectant, with respect to the total amount of the ink, is in the range of from about 5 wt % to about 50 wt %, in the range of from about 10 wt % to about 40 wt %, and in the range of from about 10 wt % to about 35 wt %. When the amount of the humectant is less than about 5 wt %, clogging of nozzles of an ink-jet recording head is not sufficiently prevented. When the amount of the humectant is more than about 50 wt %, the viscosity of the ink increases to cause difficulty in ejecting the ink.

The penetrant is used to facilitate the penetration of the ink into a recording material after printing and to adjust the surface tension of the ink. Examples of the penetrant include, without any limitations, glycol ethers typified by ethylene glycol-based alkyl ethers and propylene glycol-based alkyl ethers and the like. Examples of the ethylene glycol-based alkyl ethers include, without any limitations, ethylene glycol methyl ether, ethylene glycol-n-ethyl ether, ethylene glycol-n-propyl ether, ethylene glycol-n-butyl ether, ethylene glycol isobutyl ether, diethylene glycol methyl ether, diethylene glycol-n-ethyl ether, diethylene glycol-n-propyl ether, diethylene glycol-n-butyl ether, diethylene glycol isobutyl ether, triethylene glycol methyl ether, triethylene glycol-n-ethyl ether, triethylene glycol-n-propyl ether, triethylene glycol-n-butyl ether, triethylene glycol isobutyl ether and the like. Examples of the propylene glycol-based alkyl ethers include, without any limitations, propylene glycol methyl ether, propylene glycol-n-ethyl ether, propylene glycol-n-propyl ether, propylene glycol-n-butyl ether, dipropylene glycol methyl ether, dipropylene glycol-n-ethyl ether, dipropylene glycol-n-propyl ether, dipropylene glycol-n-butyl ether, tripropylene glycol methyl ether, tripropylene glycol-n-ethyl ether, tripropylene glycol-n-propyl ether, tripropylene glycol-n-butyl ether and the like. The amount of the penetrant, with respect to the total amount of the ink, is in the range of from about 0.3 wt % to about 10 wt %, and in the range of from about 0.5 wt % to about 7 wt %. When the amount of the penetrant is less than about 0.3 wt %, sufficient penetrability is not obtained. When the amount of the penetrant is more than about 10 wt %, the penetrability becomes excessively high, and blurring such as feathering tends to occur.

In addition to the humectant and the penetrant, another water soluble organic solvent may be added to the ink for the purposes of, for example, preventing the ink from drying at the end portions of nozzles of an ink-jet recording head, increasing the printing density and developing vivid color. Examples of such a water soluble organic solvent include, without any limitations: lower alcohols such as methyl alcohol, ethyl alcohol, n-propyl alcohol, isopropyl alcohol, n-butyl alcohol, sec-butyl alcohol, tert-butyl alcohol and the like; amides such as dimethylformamide, dimethylacetamide and the like; ketones and keto-alcohols such as acetone, diacetone alcohol and the like; ethers such as tetrahydrofuran, dioxane and the like; glycerin; pyrrolidones such as 2-pyrrolidone, N-methyl-2-pyrrolidone and the like; 1,3-dimethyl-2-imidazolidinone; and the like.

A surfactant may be added to the ink to adjust surface tension. Examples of the surfactant include, without any limitations: anionic surfactants, such as higher alcohol sulfate ester salts, liquid fatty oil sulfate ester salts and alkyl allyl sulfonates; and non-ionic surfactants such as polyoxyethylene alkyl ethers, polyoxyethylene alkyl esters, sorbitan alkyl esters and polyoxyethylene sorbitan alkyl esters; and the like.

### EXAMPLES

The present invention will now be described in more detail by the following test examples.

### (1) Ink Preparation

Inks having the compositions summarized in Tables 1 to 9 were prepared by the following methods.

### (1-1) Colorless Ink Nos. 1 to 4

54.4 parts by weight of water (ion-exchanged water), 26.0 parts by weight of glycerin and 3.0 parts by weight of dipropylene glycol-n-propyl ether were mixed together to obtain 83.4 parts by weight of a colorless aqueous ink solution. 83.4 parts by weight of the obtained colorless aqueous ink solution were gradually added under stirring into 16.6 parts by weight of an aqueous dispersion of zinc oxide fine particles (DENASYS® Y-UMN, manufactured by Nagase Colors & Chemicals Co., Ltd.; average particle diameter of 100 nm, solid content of 30 wt %). The resultant mixture was stirred for 30 minutes, then filtrated through a membrane filter having a pore diameter of 1 μm, to obtain colorless ink No. 1 comprising an amphoteric metal oxide. The amount of zinc oxide fine particles in the colorless ink No. 1 comprising an amphoteric metal oxide was 5 wt %.

Colorless ink Nos. 2 to 4 comprising an amphoteric metal oxide were prepared in the same manner as the above-described colorless ink No. 1, except that the respective components summarized in Table 1 were used.

### (1-2) Black Dye Ink Nos. 5 to 9

3.0 parts by weight of C.I. Direct Black 154, 53.4 parts by weight of water (ion-exchanged water), 24.0 parts by weight of glycerin and 3.0 parts by weight of dipropylene glycol-n-propyl ether were mixed together to obtain 83.4 parts by weight of a black dye aqueous solution. 83.4 parts by weight of the obtained black dye aqueous solution were gradually added under stirring into 16.6 parts by weight of an aqueous dispersion of zinc oxide fine particles (DENASYS® Y-UMN, manufactured by Nagase Colors & Chemicals Co., Ltd.; average particle diameter of 100 nm, solid content of 30 wt %). The resultant mixture was stirred for 30 minutes, then filtrated through a membrane filter having a pore diameter of 1 μm, to obtain black dye ink No. 5 comprising an amphoteric metal oxide. The amount of zinc oxide fine particles in the black dye ink No. 5 comprising an amphoteric metal oxide was 5 wt %.

Black dye ink Nos. 6 to 8 comprising an amphoteric metal oxide and black dye ink No. 9 not comprising an amphoteric metal oxide were prepared in the same manner as the above-described black dye ink No. 5, except that the respective components summarized in Table 2 were used.

### (1-3) Yellow Dye Ink Nos. 10 to 14

Yellow dye ink Nos. 10 to 13 comprising an amphoteric metal oxide and yellow dye ink No. 14 not comprising an amphoteric metal oxide were prepared in the same manner as the above-described black dye ink No. 5, except that the respective components summarized in Table 3 were used.

### (1-4) Magenta Dye Ink Nos. 15 to 19

Magenta dye ink Nos. 15 to 18 comprising an amphoteric metal oxide and magenta dye ink No. 19 not comprising an amphoteric metal oxide were prepared in the same manner as the above-described black dye ink No. 5, except that the respective components summarized in Table 4 were used.

### (1-5) Cyan Dye Ink Nos. 20 to 24

Cyan dye ink Nos. 20 to 23 comprising an amphoteric metal oxide and cyan dye ink No. 24 not comprising an amphoteric metal oxide were prepared in the same manner as the above-described black dye ink No. 5, except that the respective components summarized in Table 5 were used.

### (1-6) Black Pigment Ink Nos. 25 to 29

33.0 parts by weight of CAB-O-JET® 300, 21.3 parts by weight of water (ion-exchanged water), 26.0 parts by weight of glycerin, 2.0 parts by weight of dipropylene glycol-n-propyl ether, and 1.0 part by weight of polyoxyethylene lauryl ether ammonium sulfate (average polymerization degree of oxyethylene=12) were mixed together to obtain 83.3 parts by weight of a black pigment dispersion. 83.3 parts by weight of the obtained black pigment dispersion were gradually added under stirring into 16.7 parts by weight of an aqueous dispersion of zinc oxide fine particles (DENASYS® Y-UMN, manufactured by Nagase Colors & Chemicals Co., Ltd.; average particle diameter of 100 nm, solid content of 30 wt %). The resultant mixture was stirred for 30 minutes, then filtrated through a membrane filter having a pore diameter of 1 μm, to prepare the black pigment ink No. 25 comprising an amphoteric metal oxide. The amount of zinc oxide fine particles in the black pigment ink No. 25 comprising an amphoteric metal oxide was 5 wt %.

Black pigment ink Nos. 26 to 28 comprising an amphoteric metal oxide and black pigment ink No. 29 not comprising an amphoteric metal oxide were prepared in the same manner as the above-described black pigment ink No. 25, except that the respective components summarized in Table 6 were used.

### (1-7) Yellow Pigment Ink Nos. 30 to 34

15.0 parts by weight of C.I. Pigment Yellow 74, 5.0 parts by weight of polyoxyethylene lauryl ether ammonium sulfate, 15.0 parts by weight of glycerin and 65.0 parts by weight of water (ion-exchanged water) were mixed together, and the resultant mixture was subjected to dispersion in a wet sand mill using zirconia beads having a diameter of 0.3 mm as a medium to obtain a yellow pigment dispersion.

Separately, 49.1 parts by weight of water (ion-exchanged water), 27.5 parts by weight of glycerin and 2.5 parts by weight of dipropylene glycol-n-propyl ether were mixed together to prepare 79.1 parts by weight of an ink solvent. 79.1 parts by weight of the prepared ink solvent were gradually added under stirring into 20.9 parts by weight of an aqueous dispersion of zinc oxide fine particles (DENASYS® Y-UMN, manufactured by Nagase Colors & Chemicals Co., Ltd.; average particle diameter of 100 nm, solid content of 30 wt %). The resultant mixture was further stirred for 30 minutes to prepare a zinc oxide fine particle dispersion.

Then, 80 parts by weight of the prepared zinc oxide fine particle dispersion were gradually added under stirring into 20 parts by weight of the yellow pigment dispersion. The resultant mixture was further stirred for 30 minutes, then filtrated through a membrane filter having a pore diameter of 1 μm, to prepare the yellow ink No. 30 comprising an amphoteric metal oxide. The amount of zinc oxide fine particles in the yellow ink No. 30 comprising an amphoteric metal oxide was 5 wt %.

Yellow pigment ink Nos. 31 to 33 comprising an amphoteric metal oxide and yellow pigment ink No. 34 not comprising an amphoteric metal oxide were prepared in the same manner as the above-described yellow pigment ink No. 30, except that the respective components summarized in Table 7 were used.

### (1-8) Magenta Pigment Ink Nos. 35 to 39

Magenta pigment ink Nos. 35 to 38 comprising an amphoteric metal oxide and magenta pigment ink No. 39 not comprising an amphoteric metal oxide were prepared in the same manner as the above-described yellow pigment ink No. 30, except that the respective components summarized in Table 8 were used.

### (1-9) Cyan Pigment Ink Nos. 40 to 44

Cyan pigment ink Nos. 40 to 43 comprising an amphoteric metal oxide and cyan pigment ink No. 44 not comprising an amphoteric metal oxide were prepared in the same manner as the above-described yellow pigment ink No. 30, except that the respective components summarized in Table 9 were used.

TABLE 1

| | | Colorless ink | | | |
|---|---|---|---|---|---|
| | | Ink No. | | | |
| | | 1 | 2 | 3 | 4 |
| Ink | Water (ion-exchanged | 54.4 | 60.0 | 65.7 | 67.0 |
| Composition | water) | | | | |
| (wt %) | Glycerin | 26.0 | 27.0 | 28.0 | 28.3 |
| | Dipropylene glycol-n- | 3.0 | 3.0 | 3.0 | 3.0 |
| | propyl ether | | | | |
| | DENASYS ® Y-UMN⁽*¹⁾ | 16.6 | 10.0 | 3.3 | 7.7 |

⁽*¹⁾Manufactured by Nagase Colors & Chemicals Co., Ltd. Aqueous dispersion of zinc oxide fine particles. Average particle diameter of 100 nm. Solid content of 30 wt %.

TABLE 2

| | | Black dye ink | | | | |
|---|---|---|---|---|---|---|
| | | Ink No. | | | | |
| | | 5 | 6 | 7 | 8 | 9 |
| Ink | Water (ion-exchanged | 53.4 | 59.0 | 64.7 | 66.1 | 67.5 |
| composition | water) | | | | | |
| (wt %) | Glycerin | 24.0 | 25.0 | 26.0 | 26.2 | 26.5 |
| | Dipropylene glycol-n- | 3.0 | 3.0 | 3.0 | 3.0 | 3.0 |
| | propyl ether | | | | | |
| | DENASYS ® | 16.6 | 10.0 | 3.3 | 1.7 | — |
| | Y-UMN⁽*¹⁾ | | | | | |
| | C.I. Direct Black | 3.0 | 3.0 | 3.0 | 3.0 | 3.0 |
| | 154 | | | | | |

⁽*¹⁾Manufactured by Nagase Colors & Chemicals Co., Ltd. Aqueous dispersion of zinc oxide fine particles. Average particle diameter of 100 nm. Solid content of 30 wt %.

TABLE 3

| | | Yellow dye ink | | | | |
|---|---|---|---|---|---|---|
| | | Ink No. | | | | |
| | | 10 | 11 | 12 | 13 | 14 |
| Ink | Water (ion-exchanged | 53.4 | 59.0 | 64.7 | 66.1 | 67.5 |
| composition | water) | | | | | |
| (wt %) | Glycerin | 25.0 | 26.0 | 27.0 | 27.2 | 27.5 |
| | Dipropylene glycol-n- | 3.0 | 3.0 | 3.0 | 3.0 | 3.0 |
| | propyl ether | | | | | |
| | DENASYS ® | 16.6 | 10.0 | 3.3 | 1.7 | — |
| | Y-UMN⁽*¹⁾ | | | | | |
| | C.I. Direct Yellow 86 | 0.4 | 0.4 | 0.4 | 0.4 | 0.4 |
| | C.I. Direct Yellow | 1.6 | 1.6 | 1.6 | 1.6 | 1.6 |
| | 132 | | | | | |

⁽*¹⁾Manufactured by Nagase Colors & Chemicals Co., Ltd. Aqueous dispersion of zinc oxide fine particles. Average particle diameter of 100 nm. Solid content of 30 wt %.

TABLE 4

| | | Magenta dye ink | | | | |
|---|---|---|---|---|---|---|
| | | Ink No. | | | | |
| | | 15 | 16 | 17 | 18 | 19 |
| Ink | Water (ion-exchanged | 53.4 | 59.0 | 64.7 | 66.1 | 67.5 |
| composition | water) | | | | | |
| (wt %) | Glycerin | 24.5 | 25.5 | 26.5 | 26.7 | 27.0 |
| | Dipropylene glycol-n- | 3.0 | 3.0 | 3.0 | 3.0 | 3.0 |
| | propyl ether | | | | | |
| | DENASYS ® | 16.6 | 10.0 | 3.3 | 1.7 | — |
| | Y-UMN⁽*¹⁾ | | | | | |
| | C.I. Reactive Red 180 | 2.5 | 2.5 | 2.5 | 2.5 | 2.5 |

⁽*¹⁾Manufactured by Nagase Colors & Chemicals Co., Ltd. Aqueous dispersion of zinc oxide fine particles. Average particle diameter of 100 nm. Solid content of 30 wt %.

TABLE 5

| | | Cyan dye ink | | | | |
|---|---|---|---|---|---|---|
| | | Ink No. | | | | |
| | | 20 | 21 | 22 | 23 | 24 |
| Ink | Water (ion-exchanged | 53.4 | 59.0 | 64.7 | 66.0 | 67.0 |
| composition | water) | | | | | |
| (wt %) | Glycerin | 24.1 | 25.1 | 26.1 | 26.4 | 27.1 |
| | Dipropylene glycol-n- | 3.0 | 3.0 | 3.0 | 3.0 | 3.0 |
| | propyl ether | | | | | |
| | DENASYS ® | 16.6 | 10.0 | 3.3 | 1.7 | — |
| | Y-UMN⁽*¹⁾ | | | | | |
| | C.I. Direct Blue 199 | 2.9 | 2.9 | 2.9 | 2.9 | 2.9 |

⁽*¹⁾Manufactured by Nagase Colors & Chemicals Co., Ltd. Aqueous dispersion of zinc oxide fine particles. Average particle diameter of 100 nm. Solid content of 30 wt %.

TABLE 6

| | | Black pigment ink | | | | |
|---|---|---|---|---|---|---|
| | | Ink No. | | | | |
| | | 25 | 26 | 27 | 28 | 29 |
| Ink | Water (ion-exchanged | 21.3 | 27.5 | 33.7 | 35.3 | 37.0 |
| composition | water) | | | | | |
| (wt %) | Glycerin | 26.0 | 26.5 | 27.0 | 27.0 | 27.0 |
| | Dipropylene glycol-n- | 2.0 | 2.0 | 2.0 | 2.0 | 2.0 |
| | propyl ether | | | | | |
| | DENASYS ® | 16.7 | 10.0 | 3.3 | 1.7 | — |
| | Y-UMN⁽*¹⁾ | | | | | |
| | CAB-O-JET ® 300⁽*²⁾ | 33.0 | 33.0 | 33.0 | 33.0 | 33.0 |
| | Polyoxyethylene | 1.0 | 1.0 | 1.0 | 1.0 | 1.0 |
| | lauryl ether | | | | | |
| | ammonium | | | | | |
| | sulfate⁽*³⁾ | | | | | |

⁽*¹⁾Manufactured by Nagase Colors & Chemicals Co., Ltd. Aqueous dispersion of zinc oxide fine particles. Average particle diameter of 100 nm. Solid content of 30 wt %.
⁽*²⁾Manufactured by Cabot Corporation. Carbon black concentration of 15 wt %. Concentration in terms of the ink (carbon black concentration in the total amount of ink of 5 wt %.).
⁽*³⁾Average polymerization degree of oxyethylene = 12

TABLE 7

| | | Yellow pigment ink | | | | |
|---|---|---|---|---|---|---|
| | | Ink No. | | | | |
| | | 30 | 31 | 32 | 33 | 34 |
| Ink | Water (ion-exchanged | 52.3 | 58.5 | 64.7 | 65.8 | 67.0 |
| composition | water) | | | | | |
| (wt %) | Glycerin | 25.0 | 25.5 | 26.0 | 26.5 | 27.0 |
| | Dipropylene glycol-n- | 2.0 | 2.0 | 2.0 | 2.0 | 2.0 |
| | propyl ether | | | | | |
| | DENASYS ® | 16.7 | 10.0 | 3.3 | 1.7 | — |
| | Y-UMN⁽*¹⁾ | | | | | |
| | C.I. Pigment Yellow | 3.0 | 3.0 | 3.0 | 3.0 | 3.0 |
| | 74 | | | | | |
| | Polyoxyethylene | 1.0 | 1.0 | 1.0 | 1.0 | 1.0 |
| | lauryl ether | | | | | |
| | ammonium | | | | | |
| | sulfate⁽*³⁾ | | | | | |

⁽*¹⁾Manufactured by Nagase Colors & Chemicals Co., Ltd. Aqueous dispersion of zinc oxide fine particles. Average particle diameter of 100 nm. Solid content of 30 wt %.
⁽*²⁾Average polymerization degree of oxyethylene = 12

TABLE 8

| | | Magenta pigment ink | | | | |
|---|---|---|---|---|---|---|
| | | Ink No. | | | | |
| | | 35 | 36 | 37 | 38 | 39 |
| Ink | Water (ion-exchanged | 52.1 | 58.3 | 64.5 | 65.7 | 66.8 |
| composition | water) | | | | | |
| (wt %) | Glycerin | 24.0 | 24.5 | 25.0 | 25.4 | 26.0 |
| | Dipropylene glycol-n- | 2.0 | 2.0 | 2.0 | 2.0 | 2.0 |
| | propyl ether | | | | | |
| | DENASYS ® | 16.7 | 10.0 | 3.3 | 1.7 | — |
| | Y-UMN⁽*¹⁾ | | | | | |
| | C.I. Pigment Red 122 | 4.0 | 4.0 | 4.0 | 4.0 | 4.0 |
| | Polyoxyethylene | 1.2 | 1.2 | 1.2 | 1.2 | 1.2 |
| | lauryl ether | | | | | |
| | ammonium | | | | | |
| | sulfate⁽*³⁾ | | | | | |

⁽*¹⁾Manufactured by Nagase Colors & Chemicals Co., Ltd. Aqueous dispersion of zinc oxide fine particles. Average particle diameter of 100 nm. Solid content of 30 wt %.
⁽*²⁾Average polymerization degree of oxyethylene = 12

TABLE 9

| | | Cyan pigment ink | | | | |
|---|---|---|---|---|---|---|
| | | Ink No. | | | | |
| | | 40 | 41 | 42 | 43 | 44 |
| Ink | Water (ion-exchanged | 51.8 | 58.0 | 64.2 | 65.5 | 66.5 |
| composition | water) | | | | | |
| (wt %) | Glycerin | 25.5 | 26.0 | 26.5 | 26.8 | 27.5 |
| | Dipropylene glycol-n- | 2.0 | 2.0 | 2.0 | 2.0 | 2.0 |
| | propyl ether | | | | | |
| | DENASYS ® | 16.7 | 10.0 | 3.3 | 1.7 | — |
| | Y-UMN⁽*¹⁾ | | | | | |
| | C.I. Pigment Blue | 3.0 | 3.0 | 3.0 | 3.0 | 3.0 |
| | 15:3 | | | | | |
| | Polyoxyethylene | 1.0 | 1.0 | 1.0 | 1.0 | 1.0 |
| | lauryl ether | | | | | |
| | ammonium | | | | | |
| | sulfate⁽*³⁾ | | | | | |

⁽*¹⁾Manufactured by Nagase Colors & Chemicals Co., Ltd. Aqueous dispersion of zinc oxide fine particles. Average particle diameter of 100 nm. Solid content of 30 wt %.
⁽*²⁾Average polymerization degree of oxyethylene = 12

### (2) Method of Producing Recorded Matter

Each of the inks prepared in (1) was filled into a predetermined ink cartridge. Then, using a digital multifunction device equipped with an ink-jet printer (DCP-115, product of Brother Industries, Ltd.), solid printing was performed at a resolution of 600 dpi×600 dpi on a neutral filter paper (AP2507500) manufactured by Millipore Corporation.

### (3) Determination of Recorded Matter

Using aqueous citric acid solutions having a pH of 1.9, 2.6, 3.3, and 4.1, 1 drop of each solution was dropped onto a different location of a recorded portion of each recorded matter obtained from the colorless ink Nos. 1 to 4, black dye ink Nos. 5 to 9, yellow dye ink Nos. 10 to 14, magenta dye ink Nos. 15 to 19, cyan dye ink Nos. 20 to 24, black pigment ink Nos. 25 to 29, yellow pigment ink Nos. 30 to 34, magenta pigment ink Nos. 35 to 39, and cyan pigment ink Nos. 40 to 44 produced in (2). Then, one drop of the pH indicator BCP (bromocresol purple) was dropped onto the same locations on the recorded matter, and the pH of that droplet was measured from the color change of the dropped portion after the dropping.

Furthermore, the aqueous citric acid solutions and the pH indicator were dropped onto non-recorded portions of a neutral filter paper (AP2507500) manufactured by Millipore Corporation in the same manner as for the recorded portions, and the pH of the dropped portions after the dropping was measured.

Furthermore, for each pH of the aqueous citric acid solutions, the determination ability was evaluated as follows.

A: Cases where the pH of a recorded portion obtained from ink which did not comprise an amphoteric metal oxide and the pH of a recorded portion obtained from ink having a zinc oxide concentration of 0.5 wt % or more could be distinguished.
B: Cases where the pH of a recorded portion obtained from ink which did not comprise an amphoteric metal oxide and the pH of a recorded portion obtained from ink having a zinc oxide concentration of 1.0 wt % or more could be distinguished.
C: Cases where the pH of a recorded portion obtained from ink which did not comprise an amphoteric metal oxide and the pH of a recorded portion obtained from ink having a zinc oxide concentration of 3.0 wt % or more could be distinguished.
D: Cases where the pH of a recorded portion obtained from ink which did not comprise an amphoteric metal oxide and the pH of a recorded portion obtained from ink having a zinc oxide concentration of 3.0 wt % or more could not be distinguished.

The results are summarized in Tables 10 to 18.

TABLE 10

| | | | pH of Recorded portion | | | |
|---|---|---|---|---|---|---|
| | | ZnO | Aqueous | Aqueous | Aqueous | Aqueous |
| | | Concentration | Solution | Solution | Solution | Solution |
| | Color- | in the | of Citric | of Citric | of Citric | of Citric |
| | less | Ink | Acid | Acid | Acid | Acid |
| | ink No. | (wt %) | pH = 1.9 | pH = 2.6 | pH = 3.3 | pH = 4.1 |
| Test | 1 | 5.0 | pH = less | pH = 6-7 | pH = 6-7 | pH = 6-7 |
| example 1 | | | than 5 | | | |
| Test | 2 | 3.0 | pH = less | pH = 5-7 | pH = 6-7 | pH = 6-7 |
| example 2 | | | than 5 | | | |
| Test | 3 | 1.0 | pH = less | pH = less | pH = 5-7 | pH = 6-7 |
| example 3 | | | than 5 | than 5 | | |
| Test | 4 | 0.5 | pH = less | pH = less | pH = 5-7 | pH = 6-7 |
| example 4 | | | than 5 | than 5 | | |
| Test | — | 0 | pH = less | pH = less | pH = less | pH = 6-7 |
| example 5 | | | than 5 | than 5 | than 5 | |
| Evaluation | — | — | D | C | A | D |

TABLE 11

| | | | pH of Recorded portion | | |
|---|---|---|---|---|---|
| | | ZnO | Aqueous | Aqueous | Aqueous |
| | Black | Concentration | Solution | Solution | Solution |
| | dye | in the | of Citric | of Citric | of Citric |
| | ink | Ink | Acid | Acid | Acid |
| | No. | (wt %) | pH = 1.9 | pH = 2.6 | pH = 3.3 |
| Test | 5 | 5.0 | pH = less | pH = 6-7 | pH = 6-7 |
| example 6 | | | than 5 | | |
| Test | 6 | 3.0 | pH = less | pH = 5-7 | pH = 6-7 |
| example 7 | | | than 5 | | |
| Test | 7 | 1.0 | pH = less | pH = less | pH = 5-7 |
| example 8 | | | than 5 | than 5 | |
| Test | 8 | 0.5 | pH = less | pH = less | pH = 5-7 |
| example 9 | | | than 5 | than 5 | |
| Test | 9 | 0 | pH = less | pH = less | pH = less |
| example | | | than 5 | than 5 | than 5 |
| 10 | | | | | |
| Evaluation | — | — | D | C | A |

TABLE 12

| | | | pH of Recorded portion | | |
|---|---|---|---|---|---|
| | | ZnO | Aqueous | Aqueous | Aqueous |
| | Yellow | Concentration | Solution | Solution | Solution |
| | dye | in the | of Citric | of Citric | of Citric |
| | ink | Ink | Acid | Acid | Acid |
| | No. | (wt %) | pH = 1.9 | pH = 2.6 | pH = 3.3 |
| Test | 10 | 5.0 | pH = less | pH = 6-7 | pH = 6-7 |
| example | | | than 5 | | |
| 11 | | | | | |
| Test | 11 | 3.0 | pH = less | pH = 5-7 | pH = 6-7 |
| example | | | than 5 | | |
| 12 | | | | | |
| Test | 12 | 1.0 | pH = less | pH = less | pH = 5-7 |
| example | | | than 5 | than 5 | |
| 13 | | | | | |
| Test | 13 | 0.5 | pH = less | pH = less | pH = 5-7 |
| example | | | than 5 | than 5 | |
| 14 | | | | | |
| Test | 14 | 0 | pH = less | pH = less | pH = less |
| example | | | than 5 | than 5 | than 5 |
| 15 | | | | | |
| Evaluation | — | — | D | C | A |

TABLE 13

| | | | pH of Recorded portion | | |
|---|---|---|---|---|---|
| | | ZnO | Aqueous | Aqueous | Aqueous |
| | | Concentration | Solution | Solution | Solution |
| | Magenta | in the | of Citric | of Citric | of Citric |
| | dye ink | Ink | Acid | Acid | Acid |
| | No. | (wt %) | pH = 1.9 | pH = 2.6 | pH = 3.3 |
| Test | 15 | 5.0 | pH = less | pH = 6-7 | pH = 6-7 |
| example | | | than 5 | | |
| 16 | | | | | |
| Test | 16 | 3.0 | pH = less | pH = 5-7 | pH = 6-7 |
| example | | | than 5 | | |
| 17 | | | | | |
| Test | 17 | 1.0 | pH = less | pH = less | pH = 5-7 |
| example | | | than 5 | than 5 | |
| 18 | | | | | |
| Test | 18 | 0.5 | pH = less | pH = less | pH = 5-7 |
| example | | | than 5 | than 5 | |
| 19 | | | | | |
| Test | 19 | 0 | pH = less | pH = less | pH = less |
| example | | | than 5 | than 5 | than 5 |
| 20 | | | | | |
| Evalua- | — | — | D | C | A |
| tion | | | | | |

TABLE 14

| | | | pH of Recorded portion | | |
|---|---|---|---|---|---|
| | | ZnO | Aqueous | Aqueous | Aqueous |
| | Cyan | Concentration | Solution | Solution | Solution |
| | dye | in the | of Citric | of Citric | of Citric |
| | ink | Ink | Acid | Acid | Acid |
| | No. | (wt %) | pH = 1.9 | pH = 2.6 | pH = 3.3 |
| Test | 20 | 5.0 | pH = less | pH = 6-7 | pH = 6-7 |
| example | | | than 5 | | |
| 21 | | | | | |
| Test | 21 | 3.0 | pH = less | pH = 5-7 | pH = 6-7 |
| example | | | than 5 | | |
| 22 | | | | | |
| Test | 22 | 1.0 | pH = less | pH = less | pH = 5-7 |
| example | | | than 5 | than 5 | |
| 23 | | | | | |
| Test | 23 | 0.5 | pH = less | pH = less | pH = 5-7 |
| example | | | than 5 | than 5 | |
| 24 | | | | | |
| Test | 24 | 0 | pH = less | pH = less | pH = less |
| example | | | than 5 | than 5 | than 5 |
| 25 | | | | | |
| Evaluation | — | — | D | C | A |

TABLE 15

| | | | pH of Recorded portion | | |
|---|---|---|---|---|---|
| | | ZnO | Aqueous | Aqueous | Aqueous |
| | | Concentration | Solution | Solution | Solution |
| | Black | in the | of Citric | of Citric | of Citric |
| | pigment | Ink | Acid | Acid | Acid |
| | ink No. | (wt %) | pH = 1.9 | pH = 2.6 | pH = 3.3 |
| Test | 25 | 5.0 | pH = less | pH = 6-7 | pH = 6-7 |
| example | | | than 5 | | |
| 26 | | | | | |
| Test | 26 | 3.0 | pH = less | pH = 5-7 | pH = 6-7 |
| example | | | than 5 | | |
| 27 | | | | | |
| Test | 27 | 1.0 | pH = less | pH = less | pH = 5-7 |
| example | | | than 5 | than 5 | |
| 28 | | | | | |
| Test | 28 | 0.5 | pH = less | pH = less | pH = 5-7 |
| example | | | than 5 | than 5 | |
| 29 | | | | | |
| Test | 29 | 0 | pH = less | pH = less | pH = less |
| example | | | than 5 | than 5 | than 5 |
| 30 | | | | | |
| Evaluation | — | — | D | C | A |

TABLE 16

| | | | pH of Recorded portion | | |
|---|---|---|---|---|---|
| | | ZnO | Aqueous | Aqueous | Aqueous |
| | | Concentration | Solution | Solution | Solution |
| | Yellow | in the | of Citric | of Citric | of Citric |
| | pigment | Ink | Acid | Acid | Acid |
| | ink No. | (wt %) | pH = 1.9 | pH = 2.6 | pH = 3.3 |
| Test | 30 | 5.0 | pH = 6-7 | pH = 6-7 | pH = 6-7 |
| example | | | | | |
| 31 | | | | | |
| Test | 31 | 3.0 | pH = 5-7 | pH = 6-7 | pH = 6-7 |
| example | | | | | |
| 32 | | | | | |
| Test | 32 | 1.0 | pH = 5-7 | pH = 5-7 | pH = 6-7 |
| example | | | | | |
| 33 | | | | | |
| Test | 33 | 0.5 | pH = less | pH = less | pH = 6-7 |
| example | | | than 5 | than 5 | |
| 34 | | | | | |
| Test | 34 | 0 | pH = less | pH = less | pH = 6-7 |
| example | | | than 5 | than 5 | |
| 35 | | | | | |
| Evaluation | — | — | B | B | D |

TABLE 17

| | | | pH of Recorded portion | | |
|---|---|---|---|---|---|
| | | ZnO | Aqueous | Aqueous | Aqueous |
| | | Concentration | Solution | Solution | Solution |
| | Magenta | in the | of Citric | of Citric | of Citric |
| | pigment | Ink | Acid | Acid | Acid |
| | ink No. | (wt %) | pH = 1.9 | pH = 2.6 | pH = 3.3 |
| Test | 35 | 5.0 | pH = 6-7 | pH = 6-7 | pH = 6-7 |
| example | | | | | |
| 36 | | | | | |
| Test | 36 | 3.0 | pH = 5-7 | pH = 6-7 | pH = 6-7 |
| example | | | | | |
| 37 | | | | | |
| Test | 37 | 1.0 | pH = 5-7 | pH = 5-7 | pH = 6-7 |
| example | | | | | |
| 38 | | | | | |
| Test | 38 | 0.5 | pH = less | pH = less | pH = 6-7 |
| example | | | than 5 | than 5 | |
| 39 | | | | | |
| Test | 39 | 0 | pH = less | pH = less | pH = 6-7 |
| example | | | than 5 | than 5 | |
| 40 | | | | | |
| Evalua- | — | — | B | B | D |
| tion | | | | | |

TABLE 18

| | | | pH of Recorded portion | | |
|---|---|---|---|---|---|
| | | ZnO | Aqueous | Aqueous | Aqueous |
| | | Concentration | Solution | Solution | Solution |
| | Cyan | in the | of Citric | of Citric | of Citric |
| | pigment | Ink | Acid | Acid | Acid |
| | ink No. | (wt %) | pH = 1.9 | pH = 2.6 | pH = 3.3 |
| Test | 40 | 5.0 | pH = 6-7 | pH = 6-7 | pH = 6-7 |
| example | | | | | |
| 41 | | | | | |
| Test | 41 | 3.0 | pH = 5-7 | pH = 6-7 | pH = 6-7 |
| example | | | | | |
| 42 | | | | | |
| Test | 42 | 1.0 | pH = 5-7 | pH = 5-7 | pH = 6-7 |
| example | | | | | |
| 43 | | | | | |
| Test | 43 | 0.5 | pH = less | pH = less | pH = 6-7 |
| example | | | than 5 | than 5 | |
| 44 | | | | | |
| Test | 44 | 0 | pH = less | pH = less | pH = 6-7 |
| example | | | than 5 | than 5 | |
| 45 | | | | | |
| Evaluation | — | — | B | B | D |

From Tables 10 to 18, it can be seen that the ease with which an ink comprising an amphoteric metal oxide and an ink not comprising an amphoteric metal oxide can be distinguished is dependent on the concentration of the amphoteric metal oxide in the ink and the pH value of the acidic aqueous solution, and that the pH value of the acidic aqueous solution needs to be set at a high level if the concentration of the amphoteric metal oxide is low.

Furthermore, concerning each of the yellow, magenta, and cyan dye inks, and the black dye inks and black pigment inks, if the acidic aqueous solution has a pH of 1.9, inks comprising an amphoteric metal oxide cannot be distinguished from inks not comprising an amphoteric metal oxide, even when the concentration of the amphoteric metal oxide in the ink is high. For each of the yellow, magenta, and cyan pigment inks, inks comprising an amphoteric metal oxide can be distinguished from inks not comprising an amphoteric metal oxide, even if the acidic aqueous solution has a pH of 1.9. Thus, it can be seen that the ability to distinguish between inks comprising an amphoteric metal oxide and inks not comprising an amphoteric metal oxide differs even for the kind and color of the coloring agent.

The present invention is not limited to the embodiments described in the Examples, which are provided for illustrative purposes only. The material substances, their amounts used, and the conditions of producing them may be varied and modified without departing from the spirit and the scope of the invention as described herein.

What is claimed is:

1. A determining method for determining whether an ink for ink-jet recording comprises an amphoteric metal oxide or whether a recorded matter was recorded with an ink for ink-jet recording comprising an amphoteric metal oxide, the determining method comprising:
applying an acidic aqueous solution or an alkaline aqueous solution to the ink for ink-jet recording or a recorded portion of a recorded matter recorded with the ink for ink-jet recording; and
observing pH change thereof.

2. The determining method according to claim 1, wherein the ink for ink-jet recording comprises the amphoteric metal oxide in a dispersed state.

3. The determining method according to claim 1, wherein a pH indicator is applied together with the acidic aqueous solution or the alkaline aqueous solution.

4. A producing method for producing an ink for ink-jet recording, where the ink is applied to a determining method for determining whether an ink for ink-jet recording comprises an amphoteric metal oxide or whether a recorded matter was recorded with an ink for ink-jet recording comprising an amphoteric metal oxide, the determining method comprising applying an acidic aqueous solution or an alkaline aqueous solution to the ink for ink-jet recording or a recorded portion of a recorded matter recorded with the ink for ink-jet recording, and observing pH change thereof,
wherein the amphoteric metal oxide is comprised in the ink for ink-jet recording in a dispersed state.

5. An ink for piezo type ink-jet recording which is applied to a determining method for determining whether an ink for ink-jet recording comprises an amphoteric metal oxide or whether a recorded matter was recorded with an ink for ink-jet recording comprising an amphoteric metal oxide, the determining method comprising applying an acidic aqueous solution or an alkaline aqueous solution to the ink for ink-jet recording or a recorded portion of a recorded matter recorded with the ink for ink-jet recording, and observing pH change thereof,
wherein the amphoteric metal oxide is comprised in a dispersed state.

6. The ink according to claim 5, comprising a pigment.

7. An ink set for ink-jet recording which is applied to a determining method for determining whether an ink for ink-jet recording comprises an amphoteric metal oxide or whether a recorded matter was recorded with an ink for ink-jet recording comprising an amphoteric metal oxide, the determining method comprising applying an acidic aqueous solution or an alkaline aqueous solution to the ink for ink-jet recording or a recorded portion of a recorded matter recorded with the ink for ink-jet recording, and observing pH change thereof,
wherein the ink set comprises a plurality of different color inks, with at least one of the color inks comprising an amphoteric metal oxide.

8. The ink set according to claim 7, comprising a black ink comprising the amphoteric metal oxide.

9. The ink set according to claim 7, wherein the amphoteric metal oxide is comprised in the ink in a dispersed state.
